(19) United States
(12) Patent Application Publication
(10) Pub. No.: US 2014/0028234 A1
(43) Pub. Date: Jan. 30, 2014

(54) MOTOR DRIVE OVERCURRENT DETECTING CIRCUIT, MOTOR DRIVING CIRCUIT WITHOUT HEADROOM VOLTAGE LOSS, AND METHOD FOR DETECTING OVERCURRENT IN MOTOR DRIVING CIRCUIT

(71) Applicant: Samsung Electro-Mechanics Co., Ltd., Gyeonggi-do (KR)

(72) Inventors: Soo Woong Lee, Gyeonggi-do (KR); Joo Yul Ko, Gyeonggi-do (KR)

(73) Assignee: Samsung Electro-Mechanics Co., Ltd., Gyeonggi-do (KR)

(21) Appl. No.: 13/951,386

(22) Filed: Jul. 25, 2013

(30) Foreign Application Priority Data
Jul. 25, 2012 (KR) 10-2012-0081314

(51) Int. Cl. H02P 29/02

(52) U.S. Cl. CPC H02P 29/027
USPC 318/490

(57) ABSTRACT

The present invention relates to a motor drive overcurrent detecting unit, a motor driving circuit without a headroom voltage loss, and a method for detecting an overcurrent in a motor driving circuit. The motor drive overcurrent detecting circuit includes: a motor driving unit switched according to a driving control signal to drive a motor; a sensing unit for distributing a sensing current from the current flowing through the motor according to turn-on of a distribution switching element and sensing the distribution current through a sensing resistor; and an on-resistance maintaining unit for maintaining on-resistance of the turned-on distribution switching element by turning on the distribution switching element. Further, a motor driving circuit without a headroom voltage loss and a method for detecting an overcurrent in a motor driving circuit are provided.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0081314, entitled filed Jul. 25, 2012, which is hereby incorporated by reference in its entirety into this application.”

### BACKGROUND OF THE INVENTION

1. Field of the Invention

The present invention relates to a motor drive overcurrent detecting circuit, a motor driving circuit without a headroom voltage loss, and a method for detecting an overcurrent in a motor driving circuit, and more particularly, to a motor drive overcurrent detecting circuit without a voltage headroom loss due to a conventional sensing resistor, a motor driving circuit without a headroom voltage loss, and a method for detecting an overcurrent in a motor driving circuit.

2. Description of the Related Art

In a motor driving circuit for driving a motor, there may be problems such as an excessive speed increase and circuit breakdown due to an overcurrent. In order to overcome these problems, in the prior art, a sensing resistor of less than 1 ohm is inserted to check a sensing voltage and an operation of the motor driving circuit is stopped when an overcurrent occurs. However, even in case of the sensing resistor of less than 1 ohm, when an overcurrent of several A (ampere) flows, a voltage headroom loss of greater than hundreds of mV may occur. The voltage headroom loss interrupts a full swing of an output current and an output voltage of the motor driving circuit and thus reduces efficiency of a motor.

A conventional motor driving circuit having a typical structure is shown in FIG. 5.

Referring to FIG. 5, a motor driving circuit includes a motor driving unit 1 including switching elements M1 to M4 which form an H-bridge, a current sensing unit 3 consisting of a sensing resistor Rs, a low pass filter (LPF) 4, a comparator 5, and a control logic (or driving control unit) 9. In the conventional motor driving circuit, a Vsense node checks an overcurrent flowing in the circuit. Vsense is determined by multiplication of the sensing resistor Rs and a current flowing in the sensing resistor. That is, a voltage headroom as much as the voltage Vsense is consumed to check an overcurrent.

In FIG. 5, each current path is switched to flow a current therein. That is, M1 and M4, and M2 and M3 operate as a pair, respectively. At this time, the current flowing in the sensing resistor Rs is I_{M1}=I_{M2}=I_{M3}=I_{M4}. The Vsense voltage for checking an overcurrent is compared with Vref set to a certain level by the comparator 5 after passing through the LPF 4 consisting of a resistor R_{F} and a capacitor C_{F} to turn on/off a control switching unit, for example, a gate driver switch.

### RELATED ART DOCUMENT

### Patent Document

Patent Document 1: International Laid-open Patent Publication No. WO2005/064782 A1 (laid-open on Jul. 14, 2005)
Patent Document 2: US Laid-open Patent Publication No. US2008/0225456 A1 (laid-open on Sep. 18, 2008)

### SUMMARY OF THE INVENTION

The present invention has been invented in order to overcome the above-described problems and it is, therefore, an object of the present invention to provide a technology that can improve efficiency of a motor and reduce signal distortion by removing a headroom voltage loss due to a conventional sensing resistor.

In accordance with a first embodiment of the present invention to achieve the object, there is provided a motor drive overcurrent detecting circuit including: a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a ground terminal; a sensing unit including a distribution switching element connected in parallel with each sink switching element of the sink switching element group and a sensing resistor connected in series with the distribution switching element, distributes a sensing current from the current flowing through the motor according to turn-on of the distribution switching element and senses the distributed current through the sensing resistor; and an on-resistance maintaining unit for maintaining on-resistance of the turned-on distribution switching element by turning on the distribution switching element connected in parallel with the turned-on sink switching element of the sink switching element group.

At this time, in an example, the source switching element group may include a P-type first FET and a P-type second FET which operates alternately with the first FET, and the sink switching element group may include an N-type third FET and an N-type fourth FET which operates alternately with the third FET.

Further, at this time, in another example, the source and sink switching element groups may include freewheeling diodes which are connected in parallel with the FETs, respectively.

Further, in an example, the distribution switching element connected in parallel with the third FET may be a fifth FET, and the distribution switching element connected in parallel with the fourth FET may be a sixth FET which is turned on alternately with the fifth FET.

In another example, the on-resistance maintaining unit may include a current mirror circuit and maintain the on-resistance of the turned-on distribution switching element by turning on the distribution switching element connected in parallel with the turned-on sink switching element of the sink switching element group and turning off the turned-off the distribution switching element connected in parallel with the turned-off sink switching element of the sink switching element group.

Further, in accordance with an example, the on-resistance maintaining unit may include a first current mirror circuit which turns on the fifth FET and a second current mirror circuit which turns off the sixth FET, wherein the first current mirror circuit turns on the fifth FET by driving a gate of the fifth FET according to a signal equal or opposite to a driving control signal of the third FET, and the second current mirror circuit turns on the sixth FET by driving a gate of the sixth FET according to a signal equal or opposite to a driving control signal of the fourth FET.

At this time, in another example, the fifth and sixth FETs may be P-type FETs, the first current mirror circuit may include a P-type seventh FET mirrored to the fifth FET; an N-type ninth FET of which a drain electrode receives a current source; an N-type tenth FET of which a drain electrode is connected to drain and gate electrodes of the seventh FET while being mirrored to the ninth FET; and an N-type eleventh FET of which a drain electrode is connected to the gate electrodes of the ninth and tenth FETs and a source electrode is connected to the ground terminal while being turned on according to the signal equal to the driving control signal of the fourth FET, and the second current mirror circuit may include a P-type eighth FET mirrored to the sixth FET; an N-type twelfth FET of which a drain electrode receives a current source; an N-type thirteenth FET of which a drain electrode is connected to drain and gate electrodes of the eighth FET while being mirrored to the twelfth FET; and an N-type fourteenth FET of which a drain electrode is connected to the gate electrodes of the twelfth and thirteenth FETs and a source electrode is connected to the ground terminal while being turned on according to the signal equal to the driving control signal of the third FET.

In accordance with another example, the motor drive overcurrent detecting circuit may further include a low pass filter unit for removing a high-frequency noise of the signal sensed by the sensing unit; and a comparing unit for determining whether an overcurrent occurs or not by comparing the voltage signal, from which the high-frequency noise is removed, with a reference voltage signal.

Next, in accordance with a second embodiment of the present invention to achieve the object, there is provided a motor driving circuit without a headroom voltage loss including: a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a ground terminal; a driving control unit for applying the driving control signals for controlling the source and sink switching element groups of the motor driving unit; a sensing unit including a distribution switching element connected in parallel with each sink switching element of the sink switching element group and a sensing resistor connected in series with the distribution switching element, distributes a sensing current from the current flowing through the motor according to turn-on of the distribution switching element and senses the distributed current through the sensing resistor; and an on-resistance maintaining unit for maintaining on-resistance of the turned-on distribution switching element by turning on the distribution switching element connected in parallel with the turned-on sink switching element of the sink switching element group.

At this time, in an example, the source switching element group may include a P-type first FET and a P-type second FET which operates alternately with the first FET, the sink switching element group may include an N-type third FET and an N-type fourth FET which operates alternately with the third FET, the distribution switching element connected in parallel with the third FET may be a fifth FET, and the distribution switching element connected in parallel with the fourth FET may be a sixth FET which is turned on alternately with the fifth FET.

At this time, in accordance with another example, the on-resistance maintaining unit may include a first current mirror circuit which turns on the fifth FET and a second current mirror circuit which turns off the sixth FET, wherein the first current mirror circuit turns on the fifth FET by driving a gate of the fifth FET according to a signal equal or opposite to a driving control signal of the third FET, and the second current mirror circuit turns on the sixth FET by driving a gate of the sixth FET according to a signal equal or opposite to a driving control signal of the fourth FET.

Further, in an example, the motor driving circuit without a headroom voltage loss may further include a low pass filter unit for removing a high-frequency noise of the signal sensed by the sensing resistor of the sensing unit; and a comparing unit for determining whether an overcurrent occurs or not by comparing the signal, from which the high-frequency noise is removed by the loss pass filter unit, with a reference voltage signal.

At this time, in another example, the driving control unit may include a control signal generating unit for generating a pre-control signal for generating the driving control signal; a control switching unit switched on/off according to the result of determination of the comparing unit to transmit the pre-control signal; and a driving control signal applying unit for applying the driving control signal by receiving the pre-control signal from the control signal generating unit according to the switching of the control switching unit to generate the driving control signal.

Next, in accordance with a third embodiment of the present invention to achieve the object, there is provided a method for detecting an overcurrent in a motor driving circuit including a source switching element group connected to an upper side of an H-bridge to apply a power voltage to a motor and a sink switching element group connected to a lower side of the H-bridge to sink a current flowing through the motor to a ground terminal, including the steps of: driving the motor by turning on one switching element of each of the source and sink switching element groups according to a driving control signal; maintaining on-resistance of the turned-on distribution switching element by turning on the distribution switching element connected in parallel with the turned-on sink switching element of the sink switching element group and distributing a sensing current from the current flowing through the motor according to the turn-on of the distribution switching element; and detecting an overcurrent by sensing the distributed current through a sensing resistor connected in series with the distribution switching element.

At this time, in accordance with an example, the source switching element group may include P-type first and second FETs, and the sink switching element group may include N-type third and fourth FETs, wherein in the step of driving the motor, the second FET operates alternately with the first FET, the fourth FET operates alternately with the third FET, the distribution switching element connected in parallel with the third FET is a fifth FET, and the distribution switching element connected in parallel with the fourth FET is a sixth FET, and in the step of distributing the sensing current, the fifth and sixth FETs are alternately turned on.

Further, at this time, in another example, in the step of distributing the sensing current, a first current mirror circuit turns on the fifth FET by driving a gate of the fifth FET according to a signal equal or opposite to a driving control signal of the third FET, and a second current mirror circuit turns on the sixth FET by driving a gate of the sixth FET according to a signal equal or opposite to a driving control signal of the fourth FET.

Further, in accordance with an example, the step of detecting the overcurrent by sensing the current may include the steps of sensing the current through the sensing resistor; removing a high-frequency noise of the sensed signal; and determining whether the overcurrent occurs or not by comparing the voltage signal, from which the high-frequency nose is removed, with a reference voltage signal.

At this time, in another example, the method for detecting an overcurrent in a motor driving circuit may further include the step of switching on/off according to the result of determination in the step of determining whether the overcurrent occurs or not and generating and applying the driving control signals for controlling the source and sink switching element groups from pre-control signals according to switching on/off.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1a is a circuit diagram schematically showing a motor drive overcurrent detecting circuit in accordance with an embodiment of the present invention;

FIG. 1b is a circuit diagram schematically showing a configuration in which a driving control signal is applied according to the result of determination after determining whether a current detected by the overcurrent detecting circuit of FIG. 1a is an overcurrent or not in a motor driving circuit without a headroom voltage loss in accordance with another embodiment of the present invention;

FIGS. 2a and 2b are circuit diagrams schematically showing an operation of the overcurrent detecting circuit of FIG. 1a;

FIG. 3 is a flowchart schematically showing a method for detecting an overcurrent in a motor driving circuit in accordance with another embodiment of the present invention;

FIG. 4 is a flowchart schematically showing some processes of the method for detecting an overcurrent in a motor driving circuit in accordance with another embodiment of the present invention; and

FIG. 5 is a circuit diagram schematically showing a conventional motor driving circuit.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

First, a motor drive overcurrent detecting circuit in accordance with a first embodiment of the present invention will be specifically described with reference to the drawings. At this time, the reference numeral that is not mentioned in the reference drawing may be the reference numeral that represents the same element in another drawing.

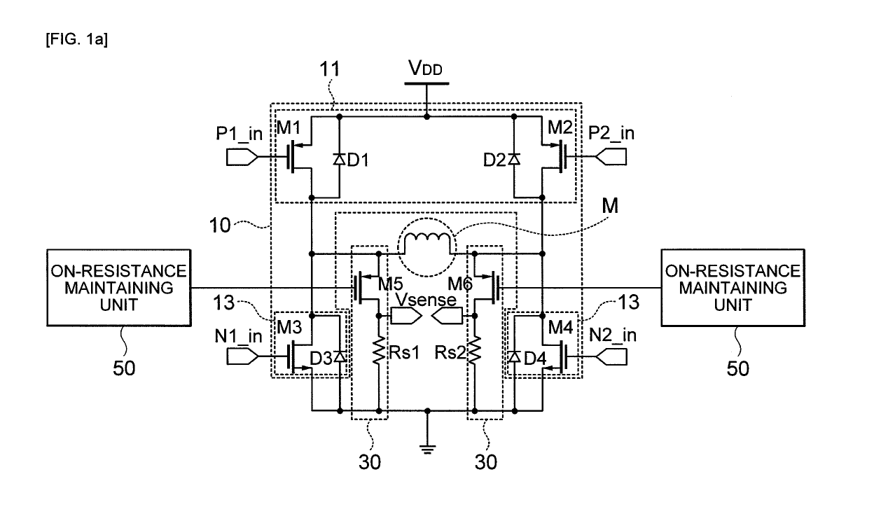

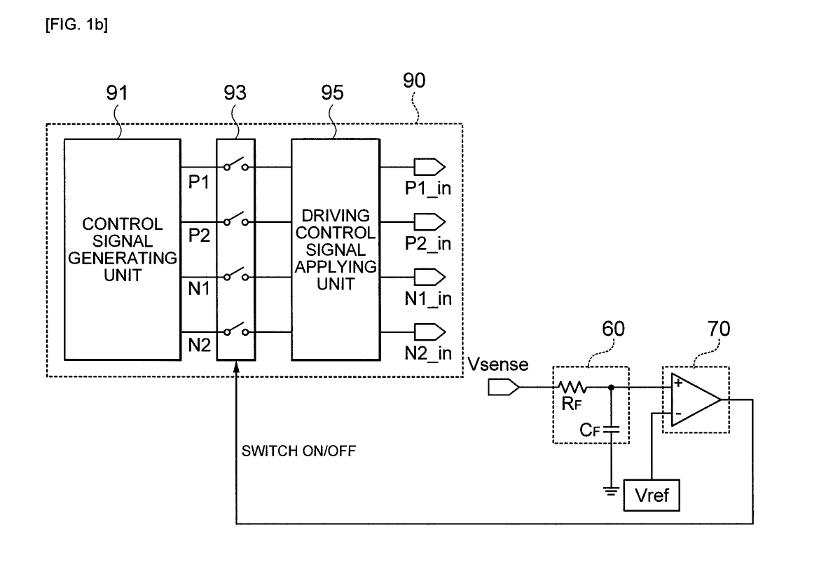

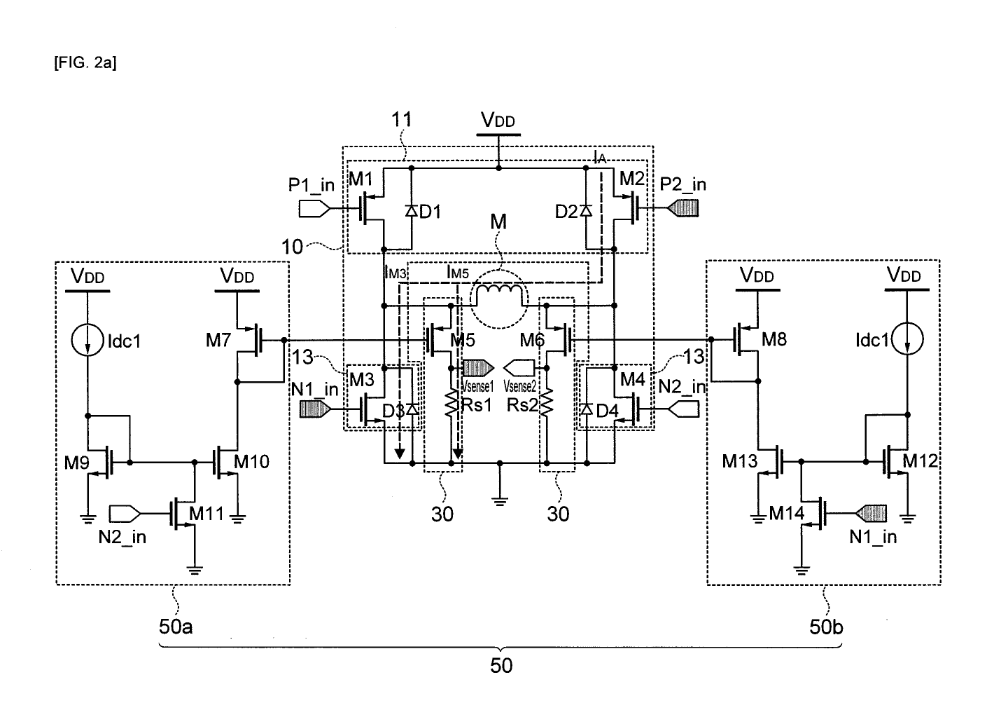

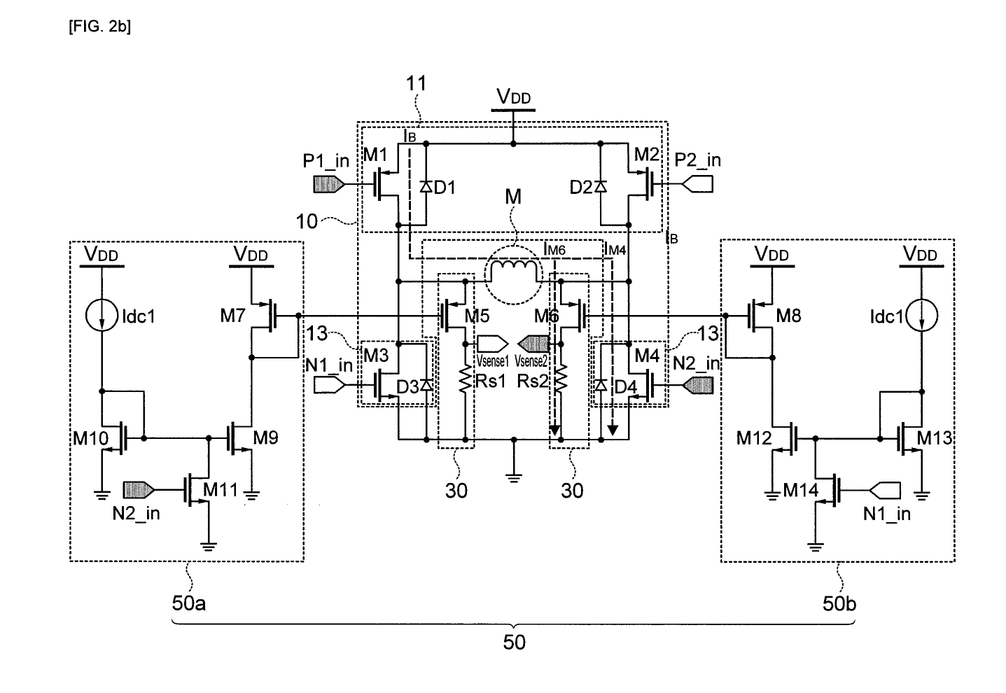

FIG. 1a is a circuit diagram schematically showing a motor drive overcurrent detecting circuit in accordance with an embodiment of the present invention, and FIGS. 2a and 2b are circuit diagrams schematically showing an operation of the overcurrent detecting circuit of FIG. 1a. Meanwhile, FIG. 1b is a circuit diagram schematically showing a configuration in which a driving control signal is applied according to the result of determination after determining whether a current detected by the overcurrent detecting circuit of FIG. 1a is an overcurrent or not.

Referring to FIG. 1a, a motor drive overcurrent detecting circuit in accordance with an example may include a motor driving unit 10, a sensing unit 30, and an on-resistance maintaining unit 50. Further, referring to FIG. 1b, the motor drive overcurrent detecting circuit may further include an LPF unit 60 and a comparing unit 70.

Specifically, the motor driving unit 10 will be described with reference to FIG. 1a.

The motor driving unit 10 includes a source switching element group 11 and a sink switching element group 13 which form an H-bridge. The source switching element group 11 is connected to a power voltage terminal VDD on an upper side of the H-bridge and applies a power voltage to a motor M according to turn-on. On the other hand, the sink switching element group 13 is connected to a lower side of the H-bridge and sinks a current flowing through the motor M to a ground terminal. Although FIG. 1a shows that the motor driving unit 10 is an H-bridge circuit which rotates the motor M forward and backward, an H-bridge circuit which drives a three-phase motor is also possible.

For example, the motor driving unit 10 receives a driving control signal from a driving control unit 90 shown in FIG. 1b and is turned on according to the driving control signal to drive the motor M. At this time, some elements of the source switching element group 11, for example, one source switching element is turned on, some elements of the sink switching element group 13, for example, one sink switching element is turned on, the power voltage of the power voltage terminal VDD is applied to the motor M through the turned-on source switching element, and an output of the current flowing through the motor M sinks to the ground terminal through the turned-on sink switching element.

An example will be specifically described with reference to FIG. 1a. The source switching element group 11 may include a P-type first FET M1 and a P-type second FET M2 which operates alternately with the first FET M1. Further, the sink switching element group 13 may include an N-type third FET M3 and an N-type fourth FET M4 which operates alternately with the third FET M3. The driving control signals, which are opposite to each other, may be applied for alternate switching in the source switching element group 11. Further, the same is for the sink switching element group 13. At this time, the driving control signal applied to the source switching element group 11 and the driving control signal applied to the sink switching element group 13 may have the same or different frequencies. For example, the frequency of the driving control signal applied to the source switching element group 11 may be higher than the frequency of the driving control signal applied to the sink switching element group 13.

Further, referring to FIG. 1a, the motor M rotates forward or backward according to the alternate operation of the P-type FETs of the source switching element group 11 and the alternate operation of the N-type FETs of the sink switching element group 13. Although not shown, in case of a three-phase motor, a source switching element group may include three P-type FET elements, and a sink switching element group may include three N-type FET elements. Even at this time, one P-type FET of the source switching element group and one N-type FET of the sink switching element group operate as a pair to drive the three-phase motor.

Further, referring to FIG. 1a, in an example, the source and sink switching element groups 11 and 13 may include freewheeling diodes D1 to D4 which are connected in parallel with the FETs, respectively. The freewheeling diodes D1 to D4, which are anti-parallel diodes, are used to protect the switching elements that drive an inductive load, that is, the motor M. Since the motor M is an inductive load, when a switching signal is changed from on to off, some of the current flowing before remains without being removed at the same time, and at this time, the freewheeling diodes play a role of making a closed loop to allow the remaining current to flow off.

Next, the sensing unit 30 will be specifically described with reference to FIG. 1a.

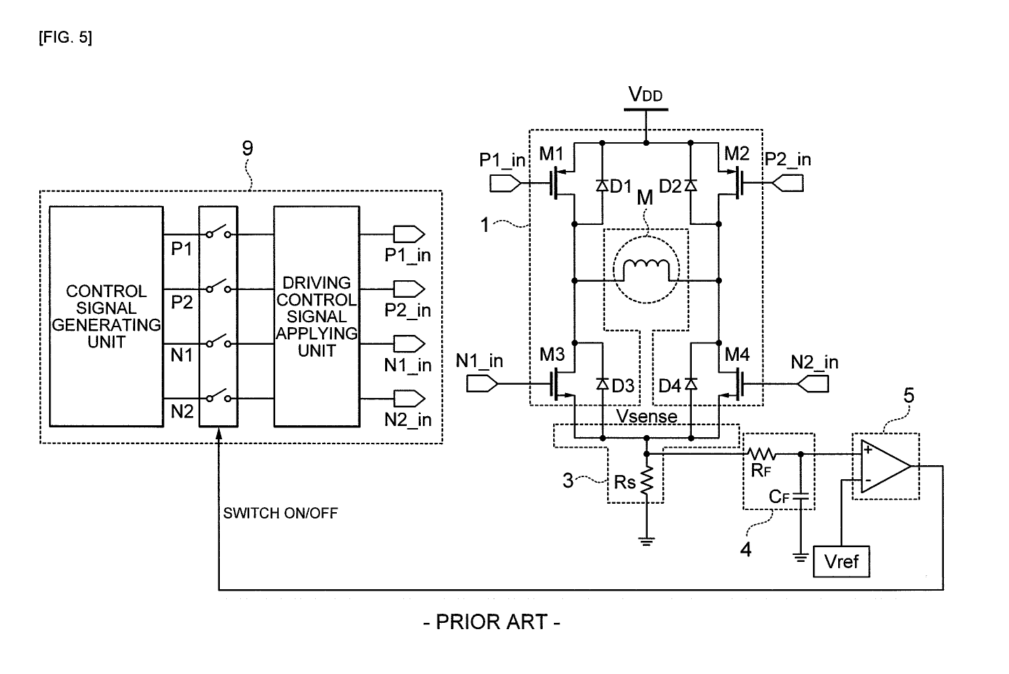

The sensing unit 30 includes distribution switching elements M5 and M6, which are connected in parallel with the respective sink switching elements, and sensing resistors Rs1 and Rs2, which are connected in series with the distribution switching elements M5 and M6. The sensing unit 30 is to remove a headroom voltage loss of a conventional sensing resistor shown in FIG. 5. A sensing current is distributed from the current flowing through the motor M according to turn-on of the distribution switching elements M5 and M6. Here, the distribution switching element is a switching element for dividing and extracting the sensing current from the current flowing through the motor M. In this specification, ‘distribution/distribute’ means ‘division/divide’ or ‘extraction/extract’ of a current. At this time, the sensing unit 30 senses the current distributed by the distribution switching elements M5 and M6 through the sensing resistors.

The sensing unit 30 distributes the current inversely proportionally to resistance of each path which forms a path connected in parallel with the turned-on sink switching element. At this time, since resistance of the sensing unit 30 is determined by on-resistance of the distribution switching elements M5 and M6 and the sensing resistors Rs1 and Rs2, unlike the prior art, it is possible to remove a headroom voltage loss by adjusting the size of the distribution switching elements M5 and M6 and the size of the sensing resistors Rs1 and Rs2.

Further, referring to FIG. 1a, in an example, when the sink switching element group 13 includes the N-type third FET M3 and the N-type fourth FET M4 which operates alternately with the third FET M3, the distribution switching elements of the sensing unit 30 may include fifth and sixth FETs M5 and M6. At this time, the fifth FET M5 as the distribution switching element is connected in parallel with the third FET M3 as the sink switching element, and the sixth FET M6 as the distribution switching element is connected in parallel with the fourth FET M4 as the sink switching element. Further, at this time, the sixth FET M6 may be turned on alternately with the fifth FET M5. For example, the fifth and sixth FET M5 and M6 may be P-type FETs as shown in FIG. 1a. In another example, unlike shown in FIG. 1a, the distribution switching elements may be N-type FETs and not P-type FETs.

Next, the on-resistance maintaining unit 50 will be specifically described with reference to FIG. 1a.

The on-resistance maintaining unit 50 of FIG. 1a maintains on-resistance of the turned-on distribution switching elements by turning on the distribution switching elements M5 and M6 connected in parallel with the turned-on sink switching elements of the sink switching element group 13.

Referring to FIGS. 2a and 2b, in another example, the on-resistance maintaining unit 50 may include a current mirror circuit. At this time, by the current mirror, it is possible to maintain the on-resistance of the turned-on distribution switching element by turning on the distribution switching element, which is connected in parallel with the turned-on sink switching element of the sink switching element group 13, and turning off the turned-off the distribution switching element connected in parallel with the turned-off sink switching element of the sink switching element group 13.

Further, referring to FIGS. 2a to 2b, when the distribution switching elements of the sensing unit 30 include the fifth and sixth FETs M5 and M6, the on-resistance maintaining unit 50 for switching the distribution switching elements will be specifically described. Unlike shown in FIGS. 2a and 2b, the distribution switching elements may include N-type FETs and not P-type FETs. Referring to FIGS. 2a and 2b, in an example, the on-resistance maintaining unit 50 may include a first current mirror circuit 50a which turns on the fifth FET M5 and a second current mirror circuit 50b which turns on the sixth FET M6.

At this time, the first current mirror circuit 50a may turn on the fifth FET M5 by driving a gate of the fifth FET M5 according to a signal equal or opposite to the driving control signal of the third FET M3. Further, the second current mirror circuit 50b may turn on the sixth FET M6 by driving a gate of the sixth FET M6 according to a signal equal or opposite to the driving control signal of the fourth FET M4. At this time, although FIGS. 2a and 2b show that the fifth and sixth FETs M5 and M6 as the distribution switching elements are P-type FETs, the fifth and sixth FETs M5 and M6 may be N-type FETs. When the fifth and sixth FETs M5 and M6 are N-type FETs, the first and second current mirror circuits may be also modified appropriately. Further, in FIGS. 2a and 2b, when the fifth and sixth FETs M5 and M6 are P-type FETs, the first and second current mirror circuits 50a and 50b turn on the fifth and sixth FETs M5 and M6 according to the signals opposite to the driving control signals of the third and fourth FETs M3 and M4 as the sink switching elements connected in parallel with the fifth and sixth FETs M5 and M6. However, in contrast, the fifth and sixth FETs M5 and M6 may be turned on according to the signals equal to the driving control signals of the third and fourth FETs M3 and M4 as the sink switching elements.

For example, more detailed description will be made with reference to FIGS. 2a and 2b. In an example, the fifth and sixth FETs M5 and M6 as the distribution switching elements may be P-type FETs. At this time, the first current mirror circuit 50a may include a P-type seventh FET M7, an N-type ninth FET M9, an N-type tenth FET M10, and an N-type eleventh FET M11. At this time, the seventh FET M7 is mirrored to the fifth FET M5. A drain electrode of the ninth FET M9 receives a current source. Further, the tenth FET M10 is mirrored to the ninth FET M9, and a drain electrode of the tenth FET M10 is connected to drain and gate electrodes of the seventh FET M7. And, the eleventh FET M11 is turned on according to the signal equal to the driving control signal of the fourth FET M4, a drain electrode of the eleventh FET M11 is connected to gate electrodes of the ninth and tenth FETs M9 and M10, and a source electrode of the eleventh FET M11 is connected to the ground terminal.

Continuously, the second current mirror circuit 50b may include a P-type eighth FET M8, an N-type twelfth FET M12, an N-type thirteenth FET M13, and an N-type fourteenth FET M14. At this time, the eighth FET M8 is mirrored to the sixth FET M6. A drain electrode of the twelfth FET M12 receives a current source. Further, the thirteenth FET M13 is mirrored to the twelfth FET M12, and a drain electrode of the thirteenth FET M13 is connected to drain and gate electrodes of the eighth FET M8. And, the fourteenth FET M14 is turned on according to the signal equal to the driving control signal of the third FET M3, a drain electrode of the fourteenth FET M14 is connected to gate electrodes of the twelfth and thirteenth FETs M12 and M13, and a source electrode of the fourteenth FET M14 is connected to the ground terminal.

Next, a motor drive overcurrent detecting circuit in accordance with another example will be described with reference to FIG. 1b. The motor drive overcurrent detecting circuit in accordance with an example may further include a low pass filter (LPF) unit 60 and a comparing unit 70. At this time, the LPF unit 60 removes a high-frequency noise of the signal sensed by the sensing unit and applies the noise-removed signal to the comparing unit 70. Further, the comparing unit 70 determines whether an overcurrent occurs or not by comparing the voltage signal, from which the high-frequency noise is removed by the LPF unit 60, with a reference voltage signal.

At this time, the result of determination of the comparing unit 70 is fed back to the driving control unit 90 of FIG. 1b so that the driving control signal is applied or blocked from the motor driving unit 10 to block an overcurrent and perform normal motor driving.

The motor drive overcurrent detecting circuit in accordance with an example of the present invention will be further described. A structure of the present invention does not have an additional voltage headroom loss due to the sensing resistor Rs as before. Further, when comparing with a conventional structure of FIG. 5, a distribution path is newly formed, and a configuration for maintaining the on-resistance of the distribution switching element, for example, the current mirror circuit is added.

Referring to FIG. 2b, as the distribution path is formed, for example, I_{M1}=I_{M4}+I_{M6}. The distribution switching elements M5 and M6 form the distribution path to detect a voltage Vsense by the sensing resistor. It is possible to implement a Vsense node for checking an overvoltage without a voltage headroom loss by forming an additional current path in addition to the sink switching elements M3 and M4.

At this time, it should be noted that resistance of the distribution A path, for example, a sum of the on-resistance of the distribution switching element M5 and resistance of the sensing resistor Rs1 and resistance of the distribution B path, for example, a sum of the on-resistance of the distribution switching element M6 and resistance of the sensing resistor Rs2 should be much greater than on-resistance of the sink switching elements M3 and M4 as a main path. This is because the size of the current flowing in the main path is related to the efficiency of the motor M. That is, in order not to deteriorate the efficiency of the motor M, most of the current flows in the main path and the current low enough to check an overcurrent flows in the distribution path formed by the distribution switching elements M5 and M6. This can be implemented by adjusting the resistance of the sensing resistor and the size of the transistors of the source switching elements M1 and M2, the sink switching elements M3 and M4, and the distribution switching elements M5 and M6.

For example, suppose that the on-resistance of the switching elements M1 and M4 is 10 ohms and a current of 1 A flows in M1. The current of 1 A flows in M6 as well as in M4. In other words, I_{M1}=I_{M4}+I_{M6}. At this time, 98% of 1 A flows in M4, and 2% of 1 A flows in M6. That is, a current of 0.98 A flows in M4, and a current of 0.02 A flows in M6. In FIG. 2b, a resistance ratio of the main B path and the distribution B path is set to 2:98. That is, when the on-resistance of the M4 is 10 ohms, the sum of the on-resistance of the M6 and the resistance of the sensing resistor Rs2 should be about 490 ohms. The resistance ratio should be determined as an optimum ratio according to the result of simulation.

Further, the switching elements M7 to M14, which form the current mirror circuit, uniformly maintain the on-resistance of the distribution switching elements M5 and M6 and turn on/off the distribution path by turning on/off the distribution switching elements M5 and M6 according to on/off of a control switching unit 93 of FIG. 1b, for example, a gate driver switch. Specifically, first, M11 and M14 turn on/off the current mirror circuit. For example, when driving control signals P1_in and N2_in are active, the distribution A path is turned off by M11. On the contrary, when driving control signals P2_in and N1_in are active, the distribution B path is turned off by M14. Thus, it is possible to reduce current consumption.

In FIG. 2b, the current of 0.02 A, which flows in the distribution switching element M6 to check an overcurrent, is multiplied with the resistance of the sensing resistor Rs2 and appears in the Vsense2 node. As shown in FIG. 1b, in the following process, after passing through the LPF unit 60, the comparing unit 70 determines whether an overcurrent occurs or not. Accordingly, the control switching unit 93, for example, the gate driver switch is turned on/off.

Next, a motor driving circuit without a headroom voltage loss in accordance with a second embodiment of the present invention will be specifically described with reference to the drawings. At this time, it is possible to refer to the above-described motor drive overcurrent detecting circuit in accordance with the first embodiment and FIGS. 1a, 2a, and 2b. Thus, repeated descriptions may be omitted.

FIG. 1b is a circuit diagram schematically showing a configuration in which a driving control signal is applied according to the result of determination after determining whether a current detected by the overcurrent detecting circuit of FIG. 1a is an overcurrent or not in a motor driving circuit without a headroom voltage loss in accordance with another embodiment of the present invention.

The motor driving circuit without a headroom voltage loss in accordance with the second embodiment of the present invention includes the above-described motor drive overcurrent detecting circuit in accordance with the first embodiment. Therefore, descriptions of components of the motor driving circuit without a headroom voltage loss in accordance with the second embodiment, which repeat the components of the motor drive overcurrent detecting circuit in accordance with the first embodiment, will refer to the above descriptions.

Referring to FIGS. 1a and 1b, a motor driving circuit without a headroom voltage loss in accordance with an example may include a motor driving unit 10, a driving control unit 90, a sensing unit 30, and an on-resistance maintaining unit 50.

At this time, the motor driving unit 10 includes a source switching element group 11 connected to an upper side of an H-bridge to apply a power voltage to a motor M and a sink switching element group 13 connected to a lower side of the H-bridge to sink a current flowing through the motor M to a ground terminal. The motor driving unit 10 is switched according to a driving control signal to drive the motor M. Although FIG. 1a shows that the motor driving unit 10 is an H-bridge circuit which rotates the motor M forward and backward, an H-bridge circuit which drives a three-phase motor is also possible.

At this time, referring to FIG. 1a, in an example, the source switching element group 11 may include a P-type first FET M1 and a P-type second FET M2 which operates alternately with the first FET M1, and the sink switching element group 13 may include an N-type third FET M3 and an N-type fourth M4 which operates alternately with the third FET M3.

In an example, the source and sink switching element groups 11 and 13 may include freewheeling diodes D1 to D4 which are connected in parallel with the FETs, respectively.

Next, the driving control unit 90 will be described with reference to FIG. 1b. The driving control unit 90 applies the driving control signals for controlling the source and sink switching element groups 11 and 13 of the motor driving unit 10.

At this time, referring to FIG. 1b, in another example, the driving control unit 90 may include a control signal generating unit 91, a control switching unit 93, and a driving control signal applying unit 95. The control signal generating unit 91 generates and outputs a pre-control signal for generally controlling the speed of the motor M and the like. The pre-control signal is a basic signal for generating the driving control signal. For example, in FIGS. 1b, P1, P2, N1, and N2 are generated and output as the pre-control signals. Next, the control switching unit 93 is switched on/off according to the result of determination of the comparing unit 70 of FIG. 1b to transmit the pre-control signal output from the control signal generating unit 91 to the driving control signal applying unit 95. Next, the driving control signal applying unit 95 receives the pre-control signal from the control signal generating unit 91 according to the switching of the control switching unit 93 and generates the driving control signal to apply the driving control signal to the motor driving unit 10.

For example, in FIG. 1b, according to the switch-on of the control switching unit 93, a driving control signal P1_in is generated from the pre-control signal P1, a driving control signal P2_in is generated from the pre-control signal P2, a driving control signal N1_in is generated from the pre-control signal N1, a driving control signal N2_in is generated from the pre-control signal N2, and the driving control signals are applied to the motor driving unit 10. At this time, each switching element of the control switching unit 93 is switched according to the result of determination of the comparing unit 70. Accordingly, the corresponding driving control signal can be generated from the transmitted pre-control signal.

Next, the sensing unit 30 of FIG. 1a will be described. The sensing unit 30 includes a distribution switching element connected in parallel with each sink switching element of the sink switching element group 13 and a sensing resistor connected in series with the distribution switching element. A sensing current is distributed from the current flowing through the motor M according to the turn-on of the distribution switching element. At this time, the sensing unit 30 senses the current distributed by the distribution switching element through the sensing resistor.

Further, referring to FIG. 1a, in an example, when the sink switching element group 13 includes N-type third and fourth FETs M3 and M4, the distribution switching elements of the sensing unit 30 may include fifth and sixth FETs M5 and M6. At this time, the fifth FET M5 as the distribution switching element is connected in parallel with the third FET M3 as the sink switching element, and the sixth FET M6 as the distribution switching element is connected in parallel with the fourth FET M4 as the sink switching element. Further, at this time, the P-type sixth FET M6 may be turned on alternately with the fifth FET M5. For example, the fifth and sixth FETs M5 and M6, as shown in FIG. 1a, may be P-type FETs, and in another example, unlike shown in FIG. 1a, the distribution switching elements may be N-type FETs and not P-type FETs.

Next, the on-resistance maintaining unit 50 of FIG. 1a will be described. The on-resistance maintaining unit 50 maintains on-resistance of the turned-on distribution switching element by turning on the distribution switching element connected in parallel with the turned-on sink switching element of the sink switching element group 13.

Referring to FIGS. 2a and 2b, in another example, the on-resistance maintaining unit 50 may include a current mirror circuit. At this time, by the current mirror, it is possible to maintain the on-resistance of the turned-on distribution switching element by turning on the distribution switching element, which is connected in parallel with the turned-on sink switching element of the sink switching element group 13, and turning off the turned-off the distribution switching element connected in parallel with the turned-off sink switching element of the sink switching element group 13.

For example, when the distribution switching elements of the sensing unit 30 include the P-type fifth and sixth FETs M5 and M6, the on-resistance maintaining unit 50 may include a first current mirror circuit 50a which turns on the P-type fifth FET M5 and a second current mirror circuit 50b which turns on the P-type sixth FET M6.

At this time, the first current mirror circuit 50a may turn on the fifth FET M5 by driving a gate of the fifth FET M5 according to a signal equal or opposite to the driving control signal of the third FET M3. Further, the second current mirror circuit 50b may turn on the sixth FET M6 by driving a gate of the sixth FET M6 according to a signal equal or opposite to the driving control signal of the fourth FET M4. At this time, although FIGS. 2a and 2b show that the fifth and sixth FETs M5 and M6 as the distribution switching elements are P-type FETs, the fifth and sixth FETs M5 and M6 may be N-type FETs. When the fifth and sixth FETs M5 and M6 are N-type FETs, the first and second current mirror circuits may be also modified appropriately. Further, in FIGS. 2a and 2b, when the fifth and sixth FETs M5 and M6 are P-type FETs, the first and second current mirror circuits 50a and 50b turn on the fifth and sixth FETs M5 and M6 according to the signals opposite to the driving control signals of the third and fourth FETs M3 and M4 as the sink switching elements connected in parallel with the fifth and sixth FETs M5 and M6. However, in contrast, the fifth and sixth FETs M5 and M6 may be turned on according to the signals equal to the driving control signals of the third and fourth FETs M3 and M4 as the sink switching elements.

Further, when describing another example of the motor driving circuit without a headroom voltage loss, the motor driving circuit may further include a low pass filter (LPF) unit 60 and a comparing unit 70. At this time, the LPF unit 60 removes a high-frequency noise of the signal sensed by the sensing unit and applies the noise-removed signal to the comparing unit 70. Further, the comparing unit 70 determines whether an overcurrent occurs or not by comparing the voltage signal, from which the high-frequency noise is removed by the LPF unit 60, with a reference voltage signal. At this time, the result of determination of the comparing unit 70 is fed back to the driving control unit 90 of FIG. 1b so that the driving control signal is applied or blocked from the motor driving unit 10 to block an overcurrent and perform normal motor driving.

Next, a method for detecting an overcurrent in a motor driving circuit in accordance with a third embodiment of the present invention will be specifically described with reference to the drawings. At this time, it is possible to refer to the above-described motor drive overcurrent detecting circuit in accordance with the first embodiment, the above-described motor driving circuit without a headroom voltage loss in accordance with the second embodiment, and FIGS. 1a, 1b, 2a, and 2b. Thus, repeated descriptions may be omitted.

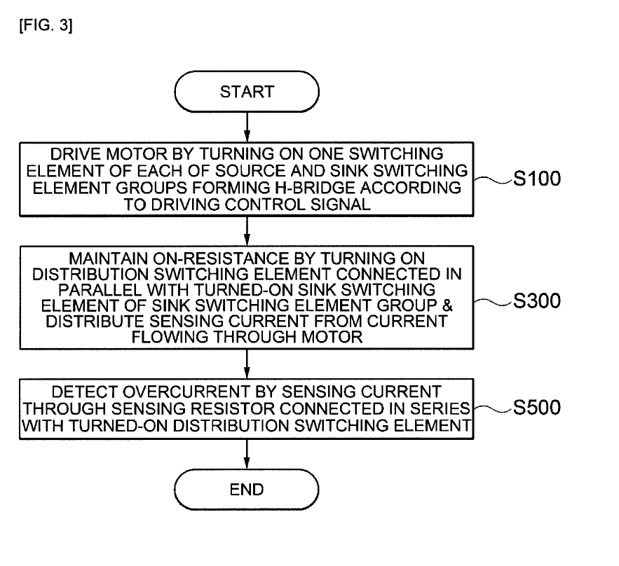

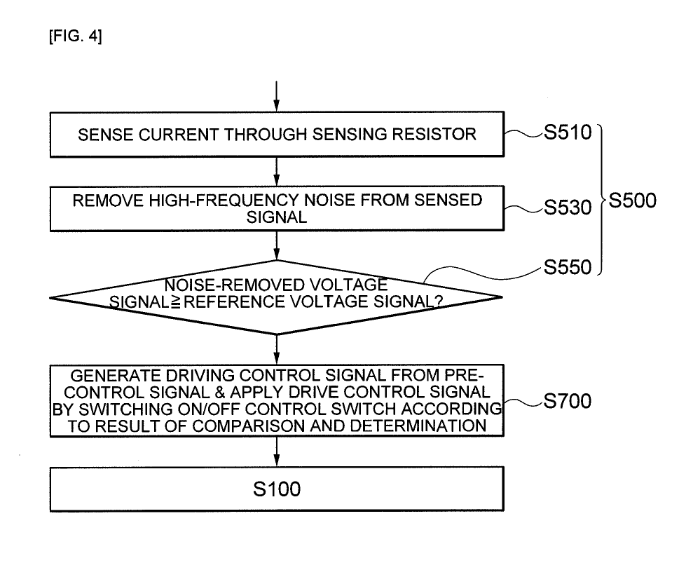

FIG. 3 is a flowchart schematically showing a method for detecting an overcurrent in a motor driving circuit in accordance with another embodiment of the present invention, and FIG. 4 is a flowchart schematically showing some processes of the method for detecting an overcurrent in a motor driving circuit in accordance with another embodiment of the present invention.

Referring to FIG. 3, a method for detecting an overcurrent in a motor driving circuit in accordance with an example is applied to a motor driving circuit including a source switching element group 11 connected to an upper side of an H-bridge to apply a power voltage to a motor M and a sink switching element group 13 connected to a lower side of the H-bridge to sink a current flowing through the motor M to a ground terminal. At this time, the method for detecting an overcurrent in a motor driving circuit may include a motor driving step S100, a current distribution step S300, and an overcurrent sensing and detecting step S500.

Specifically, in the motor driving step S100 of FIG. 3, some elements of each of the source and sink switching element groups 11 and 13, for example, one switching element is turned on according to a driving control signal to drive the motor M.

Referring to FIG. 1a, in an example, the source switching element group 11 includes P-type first and second FETs M1 and M2, and the sink switching element group 13 includes N-type third and fourth FETs M3 and M4. At this time, in the motor driving step S100, the P-type second FET M2 operates alternately with the P-type first FET M1 and the N-type fourth FET M4 operates alternately with the N-type third FET M3 to drive the motor M. In FIG. 1a, although the motor driving unit 10 is shown as an H-bridge circuit which rotates the motor M forward and backward, an H-bridge circuit which drives a three-phase motor is also possible.

Referring to FIG. 2a, when a driving control signal P1_in and a driving control signal N2_in are applied at the same time, the P-type first FET M1 of the source switching element group 11 is turned on according to the driving control signal P1_in and the power voltage is applied to the motor M through the P-type first FET M1 to drive the motor M. The N-type fourth FET M4 of the sink switching element group 13 is turned on at the same time according to the driving control signal N2_in so that the current flowing through the motor M sinks to the ground power through the N-type fourth FET M4.

For example, the driving control signal P1_in and the driving control signal P2_in may be alternately applied to the source switching element group 11, and the driving control signal N1_in and the driving control signal N2_in may be alternately applied to the sink switching element group 13. At this time, the driving control signal applied to the source switching element group 11 and the driving control signal applied to the sink switching element group 13 may have the same or different frequencies.

In an example, the source and sink switching element groups 11 and 13 may have freewheeling diodes D1 to D4 which are connected in parallel with the FETs, respectively.

Next, in the current distribution step S300 of FIG. 3, a distribution switching element, which is connected in parallel with the turned-on sink switching element of the sink switching element group 13, is turned on to maintain on-resistance of the turned-on distribution switching element. Further, in the current distribution step S300 of FIG. 3, a sensing current is distributed from the current flowing through the motor M according to the turn-on of the distribution switching element.

In another example, the sink switching element group 13 includes the N-type third and fourth FETs M3 and M4, the fifth FET M5 as the distribution switching element is connected in parallel with the third FET M3 as the sink switching element, and the sixth FET M6 as the distribution switching element is connected in parallel with the fourth FET M4 as the sink switching element. At this time, the fifth and sixth FETs M5 and M6 may be P-type FETs as shown in FIGS. 1a, 2a, and 2b, and in another example, N-type FETs and not P-type FETs.

At this time, in the current distribution step S300 of FIG. 3, the fifth FET M5 may be turned on by the first current mirror circuit 50a of FIGS. 2a and 2b, and the sixth FET M6 may be turned on by the second current mirror circuit 50b. At this time, the first and second current mirror circuits 50a and 50b may be variously modified according to the type of the fifth and sixth FETs M5 and M6 or whether current mirror driving signals for driving gates of the fifth and sixth FETs M5 and M6 are equal or opposite to the driving signals of the third and fourth FETs M3 and M4 as the sink switching elements connected in parallel with the fifth and sixth FETs M5 and M6.

For example, the first current mirror circuit 50a may turn on the fifth FET M5 by driving the gate of the fifth FET M5 according to the signal equal or opposite to the driving control signal of the third FET M3. Further, the second current mirror circuit 50b may turn on the sixth FET M6 by driving the gate of the sixth FET M6 according to the signal equal or opposite to the driving control signal of the fourth FET M4. Specifically, in FIGS. 2a and 2b, the fifth and sixth FETs M5 and M6 are P-type FETs, the first current mirror circuit 50a turns on the fifth FET M5 by sinking gate power of the fifth FET M5 according to the signal opposite to the driving control signal of the third FET M3, and the second current mirror circuit 50b turns on the sixth FET M6 by sinking gate power of the sixth FET M6 according to the signal opposite to the driving control signal of the fourth FET M4.

Next, in the overcurrent sensing and detecting step S500 of FIG. 3, an overcurrent is detected by sensing the distributed current through a sensing resistor connected in series with the distribution switching element.

The method for detecting an overcurrent in a motor driving circuit will be further described with reference to FIG. 4. Referring to FIG. 4, the overcurrent sensing and detecting step S500 may include a current sensing step S510, a high-frequency noise removing step S530, and an overcurrent determining step S550.

In the current sensing step S510, a current is sensed through the sensing resistor. Next, in the high-frequency noise removing step S530, a high-frequency noise included in the sensed signal is removed. Next, in the overcurrent determining step S550, the voltage signal, from which the high-frequency noise is removed, is compared with a reference voltage signal to determine whether an overcurrent occurs or not.

Further, referring to FIG. 4, a method for detecting an overcurrent in a motor driving circuit in accordance with another example will be described. The method for detecting an overcurrent in a motor driving circuit in accordance with an example may further include a driving control signal applying step S700. In the driving control signal applying step S700, a control switching unit is switched on/off according to the result of determination of the overcurrent determining step S550 to generate and apply the driving control signals for controlling the source and sink switching element groups 11 and 13 from pre-control signals according to the switching on/off.

According to embodiments of the present invention, it is possible to improve efficiency of a motor and reduce signal distortion by removing a headroom voltage loss due to a conventional sensing resistor.

According to an embodiment of the present invention, it is possible to improve efficiency of a motor by adjusting a current flowing in a distribution path to remove a voltage headroom voltage due to a sensing resistor in a conventional structure.

Further, in a node for checking an overcurrent, unlike a conventional structure in which an overcurrent is checked using 100% of a current passing through a motor, in an embodiment of the present invention, since it is possible to check an overcurrent with a very small current, it is possible to reduce signal distortion and implement a much more stable circuit.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A motor drive overcurrent detecting circuit comprising:
a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a ground terminal;
a sensing unit including a distribution switching element connected in parallel with each sink switching element of the sink switching element group and a sensing resistor connected in series with the distribution switching element, wherein the sensing unit distributes a sensing current from the current flowing through the motor according to turn-on of the distribution switching element and senses the distributed current through the sensing resistor; and
an on-resistance maintaining unit for maintaining on-resistance of the turned-on distribution switching element by turning on the distribution switching element connected in parallel with the turned-on sink switching element of the sink switching element group.

2. The motor drive overcurrent detecting circuit according to claim 1, wherein the source switching element group comprises a P-type first FET and a P-type second FET which operates alternately with the first FET, and the sink switching element group comprises an N-type third FET and an N-type fourth FET which operates alternately with the third FET.

3. The motor drive overcurrent detecting circuit according to claim 2, wherein the source and sink switching element groups comprise freewheeling diodes which are connected in parallel with the FETs, respectively.

4. The motor drive overcurrent detecting circuit according to claim 2, wherein the distribution switching element connected in parallel with the third FET is a fifth FET, and the distribution switching element connected in parallel with the fourth FET is a sixth FET which is turned on alternately with the fifth FET.

5. The motor drive overcurrent detecting circuit according to claim 1, wherein the on-resistance maintaining unit comprises a current mirror circuit and maintains the on-resistance of the turned-on distribution switching element by turning on the distribution switching element connected in parallel with the turned-on sink switching element of the sink switching element group and turning off the turned-off the distribution switching element connected in parallel with the turned-off sink switching element of the sink switching element group.

6. The motor drive overcurrent detecting circuit according to claim 4, wherein the on-resistance maintaining unit comprises a first current mirror circuit which turns on the fifth FET and a second current mirror circuit which turns off the sixth FET, wherein
the first current mirror circuit turns on the fifth FET by driving a gate of the fifth FET according to a signal equal or opposite to a driving control signal of the third FET, and
the second current mirror circuit turns on the sixth FET by driving a gate of the sixth FET according to a signal equal or opposite to a driving control signal of the fourth FET.

7. The motor drive overcurrent detecting circuit according to claim 6, wherein the fifth and sixth FETs are P-type FETs,
the first current mirror circuit comprises a P-type seventh FET mirrored to the fifth FET; an N-type ninth FET of which a drain electrode receives a current source; an N-type tenth FET of which a drain electrode is connected to drain and gate electrodes of the seventh FET while being mirrored to the ninth FET; and an N-type eleventh FET of which a drain electrode is connected to the gate electrodes of the ninth and tenth FETs and a source electrode is connected to the ground terminal while being turned on according to the signal equal to the driving control signal of the fourth FET, and
the second current mirror circuit comprises a P-type eighth FET mirrored to the sixth FET; an N-type twelfth FET of which a drain electrode receives a current source; an N-type thirteenth FET of which a drain electrode is connected to drain and gate electrodes of the eighth FET while being mirrored to the twelfth FET; and an N-type fourteenth FET of which a drain electrode is connected to the gate electrodes of the twelfth and thirteenth FETs and a source electrode is connected to the ground terminal while being turned on according to the signal equal to the driving control signal of the third FET.

8. The motor drive overcurrent detecting circuit according to claim 1, further comprising:
a low pass filter unit for removing a high-frequency noise of the signal sensed by the sensing unit; and
a comparing unit for determining whether an overcurrent occurs or not by comparing the voltage signal, from which the high-frequency noise is removed, with a reference voltage signal.

9. The motor drive overcurrent detecting circuit according to claim 2, further comprising:
a low pass filter unit for removing a high-frequency noise of the signal sensed by the sensing unit; and
a comparing unit for determining whether an overcurrent occurs or not by comparing the voltage signal, from which the high-frequency noise is removed, with a reference voltage signal.

10. The motor drive overcurrent detecting circuit according to claim 5, further comprising:
a low pass filter unit for removing a high-frequency noise of the signal sensed by the sensing unit; and
a comparing unit for determining whether an overcurrent occurs or not by comparing the voltage signal, from which the high-frequency noise is removed, with a reference voltage signal.

11. A motor driving circuit without a headroom voltage loss comprising:
a motor driving unit switched according to a driving control signal to drive a motor while including a source switching element group connected to an upper side of an H-bridge to apply a power voltage to the motor and a sink switching element group connected to a lower side of the H-bridge to sink a current flowing through the motor to a ground terminal;
a driving control unit for applying the driving control signals for controlling the source and sink switching element groups of the motor driving unit;
a sensing unit including a distribution switching element connected in parallel with each sink switching element of the sink switching element group and a sensing resistor connected in series with the distribution switching element, distributes a sensing current from the current flowing through the motor according to turn-on of the distribution switching element and senses the distributed current through the sensing resistor; and
an on-resistance maintaining unit for maintaining on-resistance of the turned-on distribution switching element by turning on the distribution switching element connected in parallel with the turned-on sink switching element of the sink switching element group.

12. The motor driving circuit without a headroom voltage loss according to claim 11, wherein the source switching element group comprises a P-type first FET and a P-type second FET which operates alternately with the first FET,
the sink switching element group comprises an N-type third FET and an N-type fourth FET which operates alternately with the third FET,
the distribution switching element connected in parallel with the third FET is a fifth FET, and
the distribution switching element connected in parallel with the fourth FET is a sixth FET which is turned on alternately with the fifth FET.

13. The motor driving circuit without a headroom voltage loss according to claim 12, wherein the on-resistance maintaining unit comprises a first current mirror circuit which turns on the fifth FET and a second current mirror circuit which turns off the sixth FET, wherein
the first current mirror circuit turns on the fifth FET by driving a gate of the fifth FET according to a signal equal or opposite to a driving control signal of the third FET, and
the second current mirror circuit turns on the sixth FET by driving a gate of the sixth FET according to a signal equal or opposite to a driving control signal of the fourth FET.

14. The motor driving circuit without a headroom voltage loss according to claim 11, further comprising:
a low pass filter unit for removing a high-frequency noise of the signal sensed by the sensing resistor of the sensing unit; and
a comparing unit for determining whether an overcurrent occurs or not by comparing the signal, from which the high-frequency noise is removed by the loss pass filter unit, with a reference voltage signal.

15. The motor driving circuit without a headroom voltage loss according to claim 14, wherein the driving control unit comprises:
a control signal generating unit for generating a pre-control signal for generating the driving control signal;
a control switching unit switched on/off according to the result of determination of the comparing unit to transmit the pre-control signal; and
a driving control signal applying unit for applying the driving control signal by receiving the pre-control signal from the control signal generating unit according to the switching of the control switching unit to generate the driving control signal.

16. A method for detecting an overcurrent in a motor driving circuit comprising a source switching element group connected to an upper side of an H-bridge to apply a power voltage to a motor and a sink switching element group connected to a lower side of the H-bridge to sink a current flowing through the motor to a ground terminal, comprising:
driving the motor by turning on one switching element of each of the source and sink switching element groups according to a driving control signal;
maintaining on-resistance of the turned-on distribution switching element by turning on the distribution switching element connected in parallel with the turned-on sink switching element of the sink switching element group and distributing a sensing current from the current flowing through the motor according to the turn-on of the distribution switching element; and
detecting an overcurrent by sensing the distributed current through a sensing resistor connected in series with the distribution switching element.

17. The method for detecting an overcurrent in a motor driving circuit according to claim 16, wherein the source switching element group comprises P-type first and second FETs, and the sink switching element group comprises N-type third and fourth FETs, wherein
in driving the motor, the second FET operates alternately with the first FET, the fourth FET operates alternately with the third FET, the distribution switching element connected in parallel with the third FET is a fifth FET, and the distribution switching element connected in parallel with the fourth FET is a sixth FET, and
in distributing the sensing current, the fifth and sixth FETs are alternately turned on.

18. The method for detecting an overcurrent in a motor driving circuit according to claim 17, wherein in distributing the sensing current, a first current mirror circuit turns on the fifth FET by driving a gate of the fifth FET according to a signal equal or opposite to a driving control signal of the third FET, and a second current mirror circuit turns on the sixth FET by driving a gate of the sixth FET according to a signal equal or opposite to a driving control signal of the fourth FET.

19. The method for detecting an overcurrent in a motor driving circuit according to claim 16, wherein detecting the overcurrent by sensing the current comprises:
sensing the current through the sensing resistor;
removing a high-frequency noise of the sensed signal; and
determining whether the overcurrent occurs or not by comparing the voltage signal, from which the high-frequency nose is removed, with a reference voltage signal.

20. The method for detecting an overcurrent in a motor driving circuit according to claim 19, further comprising:
switching on/off according to the result of determination in determining whether the overcurrent occurs or not and generating and applying the driving control signals for controlling the source and sink switching element groups from pre-control signals according to switching on/off.
